(19) United States
(12) Patent Application Publication
(10) Pub. No.: US 2004/0124954 A1
(43) Pub. Date: Jul. 1, 2004

(54) Composite microwave multiplexer with low coefficient of thermal expansion and method of manufacture

(76) Inventors: Michael Robert Strohecker, Palo Alto, CA (US); Brian Gregory Robins, Tracy, CA (US); Steve Holme, San Ramon, CA (US)

Correspondence Address: J.E. Kosinski, Loral Space & Communications, Ltd., Suite 303, 655 Deep Valley Drive, Rolling Hills Estates, CA, 90274, US

(21) Appl. No.: 10/331,869

(22) Filed: Dec. 30, 2002

(51) Int. Cl. H01P 1/208

(52) U.S. Cl. 333/208; 333/126

(57) ABSTRACT

A multiplexer is constructed, which has a stable volume over its thermal operating range. A composite material is used that utilizes a fabric having fibers of opposing coefficients of thermal expansion. Such fibers are assembled at an angle to each other so that resulting expansion and contractions counter act and cancel. One of the fibers is selected for its high thermal conductivity and extends over the length of the multiplexer to form a heat dissipating path.

### BACKGROUND OF THE INVENTION

1. Field of the Invention

The present invention relates to microwave multiplexers used in satellite communication systems and, more particularly, to a composite multiplexer having improved thermal performance based on an overall system having a low coefficient of thermal expansion and a high thermal conductivity heat dissipation path.

2. Brief Description of Related Developments

It is now prevalent in satellite microwave communications systems for such systems to process multiple channels. This requires the combination or separation of the channels either for transmission or for processing after acquisition. This function is usually accomplished by means of a multiplexer.

The typical multiplexer consists of a series of input channels connected to a waveguide manifold through ports defined by irises. Each of the channels are tuned and the irises designed for maximum efficiency of the overall system. The connections of the input channels to the manifold must be accurately positioned according to strict spacing requirements governed by the wavelength λ of the transmitted microwave energy. The spacing is measured along the longitudinal axis of the manifold from a shorted end.

High power, multi-carrier, microwave space antenna multiplexers are important to the communication capability of a satellite that is orbiting the earth. Conventional multiplexers are hollow tubes made preferably from a material having a low coefficient of thermal expansion and are internally metal plated to effect conductivity, a preferable plating material being copper.

The process of launching satellites into space involves a very weight conscious process. It has been calculated that the cost for launching a pound of payload material into space is on the order of many thousands of dollars. Therefore, it is incumbent upon satellite manufacturers to use materials that are lightweight, yet function with equal effectiveness as their full weight counterparts. Thus, the use of graphite or other light weight materials in the fabrication of multiplexers has evolved as a standard practice.

Since RF multiplexers are sensitive to changes in volume a significant amount of design effort involved in constructing a composite light weight multiplexer, is therefore directed to volume stability. Volume stability is an important characteristic of a microwave multiplexer in order to provide stable resonant frequencies.

It is a purpose of this invention to provide a light weight multiplexer having improved volume stability.

One factor that is significant in this effort is the thermal expansion of the multiplexers as it is subjected to changes in ambient temperature.

Different approaches attempt to use materials having a low coefficient of thermal expansion. One of such approaches involves the construction of a multiplexer from metal alloys, such as INVAR, which is an iron/nickel alloy. In this instance it is required to heat the multiplexer in order to maintain operation of the device in the geometrically stable range of the material. There is a weight penalty paid for this approach.

Another approach is to use a non thermally conductive graphite composite material, such as carbon reinforced composite. In this approach the cavities and iris' are bonded together. Because of the lack of thermal conductivity, hot spots may develop at tuning collars and irises. In addition, the coefficient of thermal expansion mismatch between the bonding adhesive and the composite structure, increases interface stresses under thermal load. A source of external heat is also needed for this approach.

Yet another approach uses an aluminum alloy in conjunction with mechanical means to compensate for volume changes.

It is an object of this invention to construct a significantly lighter multiplexer using composite materials which provide both a low coefficient of thermal expansion and reduce the need for thermal and mechanical compensation by providing high thermal conductivity.

### SUMMARY OF THE INVENTION

For illustration purposes the multiplexer of this invention comprises a pair of input channels connected to a manifold through irises. Each of the channels consists of a tube constructed of two types of carbon fibers in the form of a tape/cloth/resin matrix. One of the fibers used is selected for its negative coefficient of thermal expansion and its high thermal conductivity. The other fiber is selected for its positive coefficient of thermal conductivity. The two types of fibers are laid up on a resin impregnated tape and cloth material and cured in a tubular shape. The fibers are laid up at an angle to form a helical orientation in the cured tube. In the preferred embodiment the fibers are oriented at an angle to each other of 45° and extend in a helix around the longitudinal axis of the channel tube.

Connection flanges are bonded in place at either end of a tubular channel section that forms part of a resonant cavity. In the illustrated embodiment, a complete resonant cavity is formed by connecting two channel sections together by bolting the flanges with an iris in between. The iris is fixed to a support bracket for mounting on a frame. The flanges, irises and brackets are constructed of a carbon fiber composite material having high thermal conductivity. A thermal dissipation path away from the multiplexer to the frame is constructed in the overall assembly by the cooperation of the high thermally conductive fibers and the high thermally conductive components.

The internal surface of the channel tube is coated with copper and silver layers by a plating process to provide electrical conductivity for the resonant cavity. In operation a composite tube of this construction exhibits a near zero coefficient of thermal expansion because of the mutually compensating effects of the two types of fibers and their layup angles.

In the method of this invention the fibers are used in a tape form and laid up in angular orientation on the resin cloth which provides the matrix. The dual fiber composite is then cured into a rigid tube and plated with a conductive material on its internal surface. Connection flanges are then bonded to the tube at both ends. Multiple tubes may be connected to form a resonant cavity.

Tuning ports are drilled and tapped to receive threaded tuning plugs which are in turn drilled and tapped to accept tuning screws. To strengthen the channel tube in the area of the tuning screws, a doubler collar may be used surrounding the tube at the tuning port location. The doubler is also constructed of a high thermally conductive material to connect with the thermal dissipation path provided by the high thermally conductive fibers. The tuning plugs are secured by the engagement of threads between the plug and drilled openings and by bonding in place.

In this manner a multiplexer is constructed, which has a stable volume over its thermal operating range. A composite material is used that utilizes a fabric having fibers of opposing coefficients of thermal expansion. Such fibers are assembled at an angle to each other so that resulting expansion and contractions counter act and cancel.

### BRIEF DESCRIPTION OF THE DRAWINGS

The foregoing aspects and other features of the present invention are explained in the following description, taken in connection with the accompanying drawing in which:

FIG. 1 is a perspective view of a multiplexer according to this invention;

FIG. 2 is a perspective view of a resonant cavity according to this invention;

FIG. 3 is a perspective view of a manifold according to this invention; and

FIG. 4 is a schematic illustration of the tube material of this invention.

### DETAILED DESCRIPTION OF THE PREFERRED EMBODIMENT

The system of this invention is constructed for use in a satellite communications network in which multiple channels are commonly used. In the process of receiving and transmitting microwave signals, either at a ground station or on board an orbiting satellite, it is necessary to combine or separate the communication channels before further processing. This task is accomplished by means of a multiplexer.

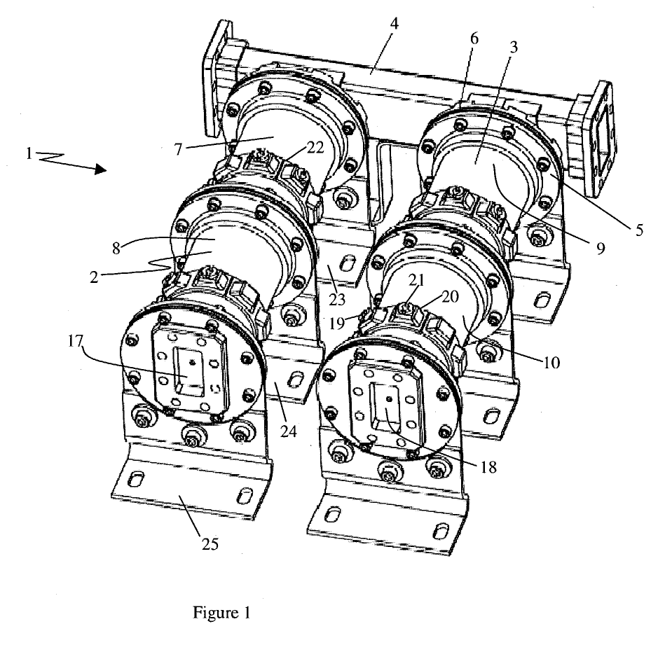

For illustration purposes an output multiplexer 1 for use on a satellite is described with reference to FIGS. 1-4. Depending on the application to which the components are adapted, the channeled output of the multiplexer 1 may be fed to an antenna (not shown) for transmission to a ground station.

For the purpose of illustration, the multiplexer 1 is shown in FIG. 1 as an assembly of two channels or resonator cavities 2 and 3 which are coupled to the manifold 4, as shown in FIG. 1. Each of the input channels 2 and 3 receive microwave signals through input ports 17 and 18 and are coupled to the manifold 4 by a coupling mechanism 5. The input channels 2 and 3 will generally be coupled through an iris 6 as part of coupling mechanism 5.

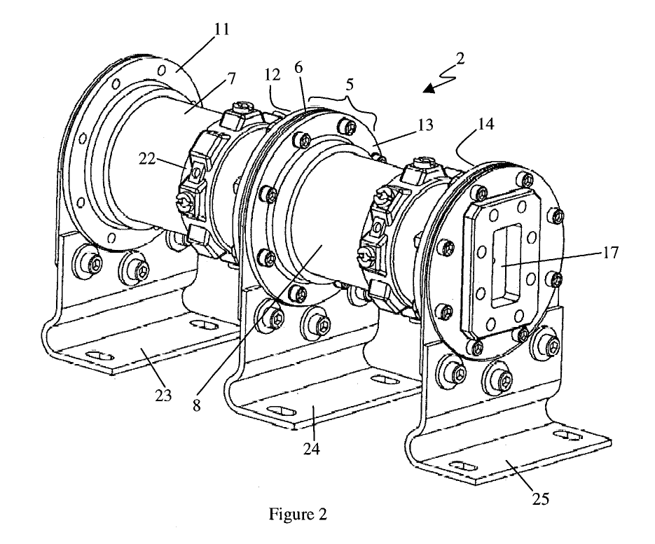

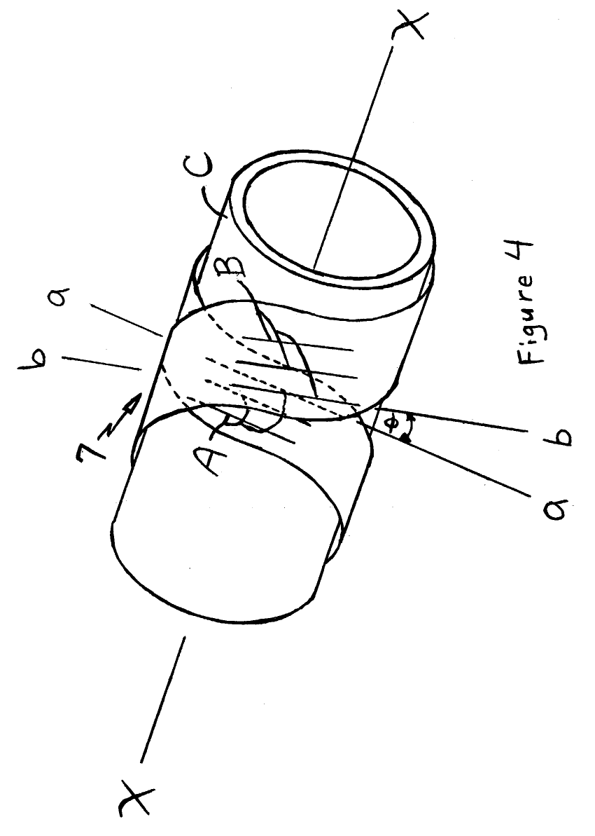

Each of the channels 2 and 3 are constructed, as shown in FIG. 2 and is an assembly of two tubular sections 7 and 8 and 9 and 10 respectively. Each tubular section is constructed, as shown in FIG. 4, of two types of carbon fibers A and B laid up on a resin impregnated cloth matrix C. One of the fibers used is selected for its negative coefficient of thermal expansion (CTE) and its high thermal conductivity, such as the pitch based fiber tape K13DTU, available from Mitsubishi. The other fiber is selected for its positive coefficient of thermal expansion and for its insulating properties, for example the pan fiber T300, manufactured by Amoco. These fibers are selected for their relatively opposing CTE's. The fibers have a longitudinal axis a-a and b-b respectively and generally are manufactured as a series of parallel extending strands in a tape like configuration. The high and low CTE fibers, A and B are laid up on resin/cloth/tape matrix C and cured in a tubular shape, such as tubular sections 7-10. The fibers A and B are laid up with their respective longitudinal axes at an angle θ to each other, to form a helical orientation in the cured tube, as shown in FIG. 4.

In the preferred embodiment, the fibers are oriented at an angle of 45° and extend in a helix around the longitudinal axis x-x of the channel tube. The angle θ can be constructed in a range of between 0 and 90 degrees. The angle is selected such that the expansion and contraction of the fibers during thermal cycling counter act each other and tend to cancel out. The laid up cured tubes are then cut to shape for further assembly.

Connection flanges, such as flanges 11-14, as shown in FIG. 2, are compression molded of a material that has high thermal conductivity, for example, 10 to 150 W/m-K. A connection flange is then bonded to both ends of tube sections 7-10. The coupling mechanism 5, as shown in FIG. 2, consists of a pair of connection flanges 12 and 13 which are bolted together with an iris 6 in between. The irises 6 are also compression molded of a high thermally conductive material and are connected to a structural frame 16 through mounting brackets 23, 24 and 25, as shown in FIG. 1. Mounting brackets 23-25 are constructed of similar material, i.e. having high thermal conductivity. The coupling mechanism 5, including flanges 11-14, irises 6, and brackets 23-25, form a high thermally conductive path to the frame for heat dissipation.

In order to provide a tuning capability within resonant cavities 2 and 3 tuning ports (not shown) may be drilled and tapped to accommodate tuning plugs, as shown in FIG. 1 at 19 and 20. Tuning plugs 19 and 20 consist of a threaded copper plug which is itself drilled and tapped to receive a copper tuning screw 21. In order to strengthen the structure of tubes section 7-10 in the area of the tuning plugs, a doubler collar, as shown at. 22 in FIG. 2, may be used. Doubler collar 22 circumscribes the tube, as shown in FIGS. 1 and 2 and has drilled and tapped holes which align with tuning ports drilled in the tubes 7-10. The doubler collar 22 is constructed of a high thermally conductive material to connect to the heat dissipating path of the overall multiplexer 1. This will assist in avoiding hot spots, which may occur at the tuning plugs.

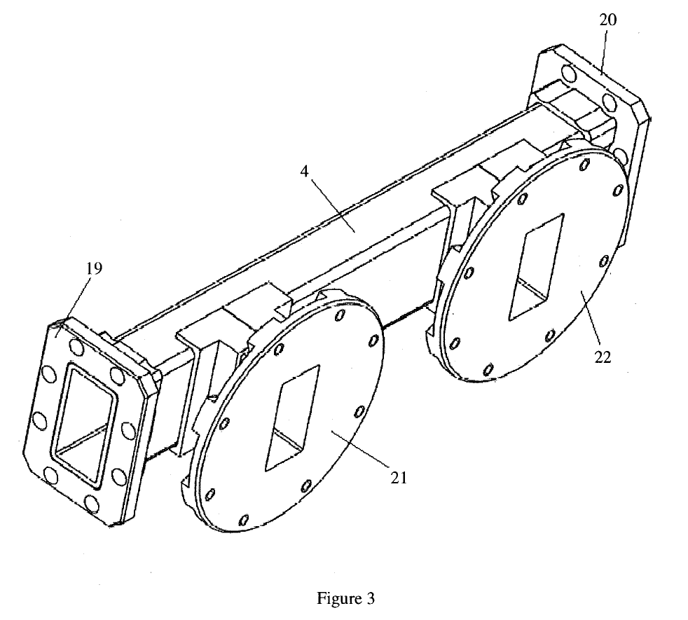

Manifold 4 is constructed similarly to the tubes 710, using fiber strands A and B laid up on a cloth/tape/resin matrix C, as described above. Connecting flanges 19-22 are compression molded as separate components using a material having high thermal conductivity. The flanges 19-22 are then bonded to the manifold 4, as shown in FIG. 3. Connecting flanges 19-22 of manifold 4 are bolted to a connecting flange of a resonant cavity, such as flange 11, in FIG. 2, to form a coupling mechanism 5, including an iris 6. The cross section of the manifold 4 is generally rectangular and the internal surface is coated with a conductive film, such as copper/silver.

To construct the resonant cavities 2 and 3. Tapes containing fibers A and B are laid up on the resin impregnated cloth C in a sticky state. The tapes are oriented relative to each other to provide an angle θ between the longitudinal axes fibers A and B. The angle θ can be in the range of 0 to 90 degrees, but an angle θ equal to 45° has proven successful. A solid composite tube is then formed by curing the laid up materials. The tube is vacuum bagged and cured under pressure in an autoclave. In this manner the tubes can be manufactured in elongated sections and cut to length as needed.

In a separate process the components of the coupling mechanism 5 are compression molded of a material having high thermal conductivity. This would include connecting flanges 11-14, as needed, irises 6, as needed and mounting brackets 23-25, as needed. If doubler collars are used, these are also compression molded in ring form with the inside diameter slightly larger than the outside diameter of the tubes 7-10. Collars 22 are then assembled in place and bonded to the tube. The connecting flanges 11-14 are then bonded in place at the ends of each tube section 7-10. A complete resonant cavity 2 or 3 may be assembled by inserting an iris element 6 between two adjacent tube sections, such as 7 and 8, and bolting the assembly together with their longitudinal axes aligned. The assembled cavity is then plated on its internal surface with a conductive film such as and alloy of copper and silver. A manifold may be constructed following a similar procedure.

In this manner a resonant cavity and multiplexer is provided which has approximately a zero coefficient of thermal expansion for the structure over a wide temperature range. This is provided by the use of dual fibers A and B having near opposite coefficients of thermal expansion. The thermal stresses generated by the diverse fibers are opposing to compensate for the thermal stress generated by changes in temperature of the multiplexer. This is accomplished while providing an effective thermal dissipation path away from the cavity through the cooperation of a fiber of high thermal conductivity with components having a similar characteristic. This performance improvement is accomplished while reducing the weight of the multiplexer to one/sixth of comparably performing units.

It should be understood that the foregoing description is only meant to be illustrative of the invention. Various alternatives and modifications can be devised by those skilled in the art without departing from the invention. The present invention is intended to embrace all such alternatives, modifications and variances which fall within the scope of the appended claims.

What is claimed is:

1. In a radio frequency multiplexer used in a satellite communication system, a resonant cavity element comprising:
a tubular member having a cured composite material structure, said structure further comprising:
a matrix having a curable resin impregnated therein;
a first series of fibers having a positive coefficient of thermal expansion, said fibers aligned along a first longitudinal axis laid up on said matrix;
a second series of fibers having a negative coefficient of thermal expansion, said fibers aligned along a second longitudinal axis laid up on said matrix; and
wherein said first and second series of fibers are oriented relative to each other such that said first and second longitudinal axes are at an angle which results in the relative expansion and contraction of said first and second series of fibers being in opposition to minimize thermal stress.

2. In a radio frequency multiplexer used in a satellite communication system, a resonant cavity element, according to claim 1 wherein the first series of fibers is characterized by low thermal conductivity and the second series of fibers is characterized by high thermal conductivity.

3. In a radio frequency multiplexer used in a satellite communication system, a resonant cavity element, according to claim 1 wherein said angle is in the range of 0 to 90 degrees.

4. In a radio frequency multiplexer used in a satellite communication system, a resonant cavity element, according to claim 1 wherein said angle is 45 degrees.

5. In a radio frequency multiplexer used in a satellite communication system, a resonant cavity element, according to claim 2, further comprising connecting flanges constructed of a material having high thermal conductivity, said connecting flanges bonded at the ends of said tubular element and thermally connected to said second series of fibers to form a heat dissipation path.

6. In a radio frequency multiplexer used in a satellite communication system, a resonant cavity element, according to claim 5, further comprising
an iris element, constructed of a material having high thermal conductivity and mounted on said connecting flange;
a support bracket constructed of a material having high thermal conductivity and attached to said iris element to support said resonant cavity element on a frame; and
wherein said connecting flanges, said iris element and said support bracket cooperate with said second series of fibers to form a heat dissipation path having high thermal conductivity.

7. In a radio frequency multiplexer used in a satellite communication system, a resonant cavity element, according to claim 1, wherein a conductive film is coated on the internal surface of said tubular element by means of plating.

8. In a radio frequency multiplexer used in a satellite communication system, a resonant cavity element, according to claim 1, further comprising a tuning assembly, said tuning assembly comprising:
a tuning collar constructed of a material having a high thermal conductivity, said tuning collar mounted about the circumference of said tubular element at a predetermined axial position;
tuning ports drilled and tapped about the periphery of said tuning collar and extending through said tubular element;
a tuning plug threaded for engagement with the threads of the tuning port, said tuning plug being drilled and tapped to receive a tuning screw; and
a tuning screw adjustably mounted in said tuning plug;
wherein said tuning collar is thermally connected to the second fibers.

9. A resonant cavity for use as part of a multiplexer of a satellite communication system comprising:
first and second tubular sections, each having a cured composite material structure, said structure further comprising:
a matrix having a curable resin impregnated therein;
a first series of fibers having a positive coefficient of thermal expansion, said fibers aligned along a first longitudinal axis laid up on said matrix, wherein the first series of fibers is characterized by low thermal conductivity;
a second series of fibers having a negative coefficient of thermal expansion, said fibers aligned along a second longitudinal axis laid up on said matrix, wherein second series of fibers is characterized by high thermal conductivity;
wherein said first and second series of fibers are oriented relative to each other such that said first and second longitudinal axes are at an angle which results in the relative expansion and contraction of said first and second series of fibers being in opposition to minimize thermal stress; and
wherein said resonant cavity further comprises connecting flanges constructed of a material having high thermal conductivity, said connecting flanges bonded at the ends of said first and second tubular elements and thermally connected to said second series of fibers to form a heat dissipation path; and
wherein said first and second tubular elements are connected in axial alignment by the attachment of adjacent connecting flanges to form a continuous cavity.

10. A resonant cavity for use as part of a multiplexer of a satellite communication system, according to claim 9, wherein said angle is in the range of 0 to 90 degrees.

11. A resonant cavity for use as part of a multiplexer of a satellite communication system, according to claim 9, wherein said angle is 45 degrees.

12. A resonant cavity for use as part of a multiplexer of a satellite communication system, according to claim 9 further comprising:
multiple iris elements, constructed of a material having high thermal conductivity and mounted on said connecting flanges;
multiple support brackets constructed of a material having high thermal conductivity and attached to said iris elements to support said resonant cavity on a frame; and
wherein said connecting flanges, said iris elements and said support brackets cooperate with said second series of fibers to form a heat dissipation path having high thermal conductivity.

13. A resonant cavity for use as part of a multiplexer of a satellite communication system, according to claim 9, wherein a conductive film is coated on the internal surface of said tubular element by means of plating.

14. A resonant cavity for use as part of a multiplexer of a satellite communication system, according to claim 9, further comprising a tuning assembly, said tuning assembly comprising:
a tuning collar constructed of a material having a high thermal conductivity, said tuning collar mounted about the circumference of said tubular element at a predetermined axial position;
tuning ports drilled and tapped about the periphery of said tuning collar and extending through said tubular element;
a tuning plug threaded for engagement with the threads of the tuning port, said tuning plug being drilled and tapped to receive a tuning screw; and
a tuning screw adjustably mounted in said tuning plug;
wherein said tuning collar is thermally connected to the second fibers.

15. A multiplexer for use in a satellite communication system comprising:
at least first and second resonant cavities, each having a cured composite material structure, said structure further comprising:
a matrix having a curable resin impregnated therein;
a first series of fibers having a positive coefficient of thermal expansion, said fibers aligned along a first longitudinal axis laid up on said matrix, wherein the first series of fibers is characterized by low thermal conductivity;
a second series of fibers having a negative coefficient of thermal expansion, said fibers aligned along a second longitudinal axis laid up on said matrix, wherein second series of fibers is characterized by high thermal conductivity;
wherein said first and second series of fibers are oriented relative to each other such that said first and second longitudinal axes are at an angle which results in the relative expansion and contraction of said first and second series of fibers being in opposition to minimize thermal stress; and
wherein said resonant cavities further comprise connecting flanges constructed of a material having high thermal conductivity, said connecting flanges bonded at the ends of said resonant cavities and thermally connected to said second series of fibers to form a heat dissipation path;
a manifold having a cured composite material structure, said structure further comprising:
a matrix having a curable resin impregnated therein;
a first series of fibers having a positive coefficient of thermal expansion, said fibers aligned along a first longitudinal axis laid up on said matrix, wherein the first series of fibers is characterized by low thermal conductivity;
a second series of fibers having a negative coefficient of thermal expansion, said fibers aligned along a second longitudinal axis laid up on said matrix, wherein second series of fibers is characterized by high thermal conductivity;
wherein said first and second series of fibers are oriented relative to each other such that said first and second longitudinal axes are at an angle which results in the relative expansion and contraction of said first and second series of fibers being in opposition to minimize thermal stress; and
wherein said manifold further comprises connecting flanges constructed of a material having high thermal conductivity, said connecting flanges bonded at the ends of said manifold and thermally connected to said second series of fibers to form a heat dissipation path; and
wherein said at least first and second resonant cavities are connected to the manifold by the attachment of adjacent connecting flanges of said resonant cavities and said manifold.

16. A multiplexer for use in a satellite communication system, according to claim 15, wherein said angle of said first and second fibers is in the range of 0 to 90 degrees.

17. A multiplexer for use in a satellite communication system, according to claim 15, wherein said angle is 45 degrees.

18. A multiplexer for use in a satellite communication system, according to claim 15, further comprising:
multiple iris elements, constructed of a material having high thermal conductivity and mounted on said connecting flanges of said resonant cavities;
multiple support brackets constructed of a material having high thermal conductivity and attached to said iris elements to support said multiplexer on a frame; and
wherein said connecting flanges, said iris elements and said support brackets cooperate with said second series of fibers in said resonant cavities and said manifold to form a heat dissipation path having high thermal conductivity.

19. A multiplexer for use in a satellite communication system, according to claim 15, wherein a conductive film is coated on the internal surface of said resonant cavities and manifold by means of plating.

20. A multiplexer for use in a satellite communication system, according to claim 15, further comprising a tuning assembly, said tuning assembly comprising:
a tuning collar constructed of a material having a high thermal conductivity, said tuning collar mounted about the circumference of said tubular element at a predetermined axial position;
tuning ports drilled and tapped about the periphery of said tuning collar and extending through said tubular element;
a tuning plug threaded for engagement with the threads of the tuning port, said tuning plug being drilled and tapped to receive a tuning screw; and
a tuning screw adjustably mounted in said tuning plug;
wherein said tuning collar is thermally connected to the second fibers.

21. A method of manufacturing a tubular section of a multiplexer for use in satellite communications, said method comprising the steps of:
providing a matrix having a curable resin impregnated therein;
laying up, on said matrix, a first series of fibers having a positive coefficient of thermal expansion, said fibers aligned along a first longitudinal axis;
laying up, on said matrix, a second series of fibers having a negative coefficient of thermal expansion, said fibers aligned along a second longitudinal axis;
curing said assembly of laid up fibers into a tubular form, and
wherein, during said lay up steps, said first and second series of fibers are oriented relative to each other, such that said first and second longitudinal axes are at an angle which results in the relative expansion and contraction of said first and second series of fibers being in opposition to minimize thermal stress.

22. A method of manufacturing a tubular section of a multiplexer for use in satellite communications, said method, according to claim 21, wherein the first series of fibers is characterized by low thermal conductivity and the second series of fibers is characterized by high thermal conductivity.

23. A method of manufacturing a tubular section of a multiplexer for use in satellite communications, said method, according to claim 21, wherein, said angle is in the range of 30 to 90 degrees.

24. A method of manufacturing a tubular section of a multiplexer for use in satellite communications, said method, according to claim 21, wherein said angle is 45 degrees.

25. A method of manufacturing a tubular section of a multiplexer for use in satellite communications, said method, according to claim 22, further comprising the steps of:
constructing multiple connecting flanges of a material having high thermal conductivity; and
bonding said connecting flanges to the ends of said tubular section in thermal connection with said second series of fibers to form a heat dissipation path.

26. A method of manufacturing a tubular section of a multiplexer for use in satellite communications, said method, according to claim 25, further comprising the steps of:
constructing multiple iris elements, of a material having high thermal conductivity;
mounting said multiple iris elements on said connecting flanges;
constructing multiple support brackets constructed of a material having high thermal conductivity;
attaching said support brackets to said iris elements; and
wherein said connecting flanges, said iris elements and said support brackets cooperate with said second series of fibers to form a heat dissipation path having high thermal conductivity.

27. A method of manufacturing a tubular section of a multiplexer for use in satellite communications, said method, according to claim 21, further comprising the step of plating a conductive film on the internal surface of said tubular element.

28. A method of manufacturing a tubular section of a multiplexer for use in satellite communications, said method, according to claim 21, further comprising
constructing a tuning assembly comprising the steps of:
constructing a tuning collar of a material having a high thermal conductivity, mounting said tuning collar about the circumference of said tubular section at a predetermined axial position;
drilling and tapping tuning ports about the periphery of said tuning collar and extending through said tubular section;
constructing a tuning plug threaded for engagement with the threads of the tuning port;
drilling and tapping said tuning plug to receive a tuning screw; and
adjustably mounting a tuning screw in said tuning plug;
wherein said tuning collar is thermally connected to the second fibers.

29. A method of manufacturing a tubular section of a multiplexer for use in satellite communications, said method, according to claim 26, further comprising the steps of:
assembling at least two of said tubular sections in axial alignment by engaging adjacent connecting flanges to form a resonant cavity;
inserting an iris element between said adjacent connecting flanges;
bolting said flanges together to join the tubular sections together;
connecting a mounting bracket to each of said iris elements; and
connecting said mounting bracket to a frame to form a thermal dissipation path of high thermal conductivity between said resonant cavity and said frame.

30. A method of manufacturing a tubular section of a multiplexer for use in satellite communications, said method, according to claim 29, wherein said connecting flanges, said iris elements, and said mounting brackets are compression molded.

31. A method of manufacturing a tubular section of a multiplexer for use in satellite communications, said method, according to claim 29, further comprising the steps of:
constructing a manifold, further comprising the steps of:
providing a matrix having a curable resin impregnated therein;
laying up, on said matrix, a first series of fibers having a positive coefficient of thermal expansion, said fibers aligned along a first longitudinal axis, wherein said first series of fibers is characterized by low thermal conductivity;
laying up, on said matrix, a second series of fibers having a negative coefficient of thermal expansion, said fibers aligned along a second longitudinal axis, wherein said second series of fibers is characterized by high thermal conductivity;
curing said assembly of laid up fibers into a tubular form,
wherein, during said lay up steps, said first and second series of fibers are oriented relative to each other, such that said first and second longitudinal axes are at an angle which results in the relative expansion and contraction of said first and second series of fibers being in opposition to minimize thermal stress;
constructing multiple connecting flanges of a material having high thermal conductivity;
bonding said connecting flanges to the ends of said manifold in thermal connection with said second series of fibers to form a heat dissipation path;
connecting said manifold with a plurality of said resonant cavities through said connecting flanges of said manifold and said resonant cavities to form a continuous thermal dissipation path with said resonant cavities.
